(19) United States
(12) Patent Application Publication
(10) Pub. No.: US 2026/0368248 A1
(43) Pub. Date: Nov. 19, 2026

(54) AUTOMATION OF MEASUREMENT DATA ENTRY

(71) Applicant: Evident Scientific, Inc., Waltham, MA (US)

(72) Inventor: James B. Costales, Watertown, MA (US)

(21) Appl. No.: 19/139,550

(22) PCT Filed: Dec. 21, 2023
(86) PCT No.: PCT/US2023/085510

§ 371 Date: Jun. 16, 2025

Related U.S. Application Data
(60) Provisional application No. 63/477,244, filed on Dec. 27, 2022.

(51) Int. Cl. G06F 16/583; G06T 7/20; G06V 10/22

(52) U.S. Cl. CPC G06F 16/583; G06T 7/20; G06V 10/22; G06T 2207/10016

(57) ABSTRACT

Data entry for logging of measurements can be automated through the use of an analysis of one or more bitmap images, such as included in a video stream. For example, a mechanical measurement instrument such as a digital thickness gauge can include a display that is placed in the field of view of a digital image sensor. One or more measurement values can be extracted from corresponding bitmap images from a captured video stream, such as in an automated manner in response to a stability criterion being met or in response to another triggering operation. An extracted measurement value can be automatically logged, such as provided to another application, or captured on an electronic form in an appropriate field, such as having an appropriate scale or unit of measure. Such an approach facilitates automation of measurement logging for instruments lacking any wired or wireless networking capability.

### CLAIM OF PRIORITY

This patent application claims the benefit of priority Costales, U.S. Provisional Patent Application Number 63/477,244, titled “AUTOMATION OF THICKNESS MEASUREMENT DATA ENTRY,” filed on Dec. 27, 2022 (Attorney Docket No. 6409.251PRV), which is hereby incorporated by reference herein in its entirety.

### FIELD OF THE DISCLOSURE

This document pertains generally, but not by way of limitation, to apparatus and techniques for inspection such as facilitating mechanical inspection, and more particularly, to apparatus and techniques for performing automated or semi-automated entry of measurement data from digital gauging apparatus (e.g., a thickness gauge), and optionally, associated metadata.

### BACKGROUND

Non-destructive testing (NDT) can refer to use of one or more different techniques to inspect regions on or within an object, such as to ascertain whether flaws or defects exist, or to otherwise characterize the object being inspected. For example, a material thickness can be measured such as using a measurement instrument configured to perform measurements non-destructively using a magnetic or acoustic (e.g., ultrasonic) technique. As an illustrative example of a mechanical measurement instrument, a thickness gauge instrument can be used for characterization of material thickness such as supporting inspection for manufacturing or corrosion monitoring, as illustrative examples. A thickness gauge instrument can be a stand-alone instrument comprising a transducer, display, and user input. The stand-alone instrument may not include or be coupled with any storage facility for capturing measurement data and associated metadata (e.g., traceability information such as acquisition date, location, identifier of a workpiece or other object under test). Accordingly, in one approach, a user may be transcribing measurement information and associated metadata by hand either into a written log or an electronic device (e.g., a form) using hand entry of data, or storage of data in a removable non-volatile medium such as a disc or flash memory device.

### SUMMARY OF THE DISCLOSURE

Various mechanical measurement instruments, such as measurement instruments providing a digital display, have been available for many years. Many such mechanical measurement instruments lack any wired or wireless networking capability either due to age or by design, or such networking capabilities are not always usable in the field. Accordingly, for devices with no wireless or wired networking capability, such as legacy devices, or for devices where network connectivity is not available, measurements are acquired manually, and results are handwritten or manually entered into an electronic form, or stored in removable non-volatile medium as a mentioned above. The present inventor has recognized that such hand entry is inefficient and error prone because it is a manual process, and use of removable media is deprecated due to compatibility, data longevity, and security concerns. The present subject matter can be used to automate data entry through the use of an analysis of one or more bitmap images, such as included in a video stream. For example, a mechanical measurement instrument such as a digital thickness gauge can include a display that is placed in the field of view of a digital image sensor. The image sensor could also capture other contextual information such as for recording or confirming a location where testing is being performed.

One or more measurement values can be extracted from corresponding bitmap images from a captured video stream, or another representation (e.g., graphical) can be extracted such as representing a plot (e.g., A-scan representation, eddy current impedance plane, or the like), such as in an automated manner in response to a stability criterion being met or in response to another triggering operation. An extracted measurement value can be automatically logged, such as provided to another application, or captured on an electronic form in an appropriate field, such as having an appropriate scale or unit of measure. Such an approach facilitates automation of measurement logging for instruments lacking any wired or wireless networking capability.

Image acquisition for such logging can be performed using an image sensor (e.g., a digital camera) included as a portion of a smart device such as a mobile device, a tablet device, a laptop device, or a wearable device (e.g., a watch, goggles, or glasses). Other data can be captured from acquired images, such as used for control or traceability related to automated measurement extraction, such as metadata used for identifying or logging a make, model, or serial number of the mechanical measurement instrument.

Generally, according to the present subject matter, mechanical measurement instruments lacking networking capabilities or automation can be integrated in an automated or semi-automated measurement acquisition workflow. Optionally, where supported by the mechanical measurement instrument, on-board operating software or firmware in the mechanical measurement instrument can be established or modified to use the display of the measurement instrument to facilitate (e.g., optically prompt or trigger) an automatic measurement logging process.

In an example, a machine-implemented method for acquiring measurement data from a non-destructive measurement instrument, without requiring a wired or wireless network connection to the non-destructive measurement instrument, can include receiving a bitmap image of a display of the non-destructive measurement instrument using an image sensor, determining whether the bitmap image of the display contains a measurement that is valid for capture, and in response, if the determination indicates the measurement is valid for capture, capturing the measurement in a record by extracting a value of the measurement from the bitmap image and storing the value. In an example, the bitmap image is, optionally, amongst bitmap images comprising a video stream. In an example, determining whether the bitmap image of the display contains a valid measurement for capture comprises receiving a selection from a user, triggering capture of the measurement in the record. In an example, determining whether the bitmap image of the display contains a valid measurement for capture comprises automatically evaluating a stability criterion. For example, the stability criterion comprises extracting a series of measurement values from respective bitmap images comprising the video stream, and triggering capture of the measurement in the record when the series of values indicate that the measurement has stabilized. In an example, a system can perform a machine-implemented method of any examples herein.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising a system that can be used to perform a machine-implemented method for acquiring measurement data from a non-destructive measurement instrument, without requiring a wired or wireless network connection to the measurement instrument.

FIG. 2 illustrates generally a technique, such as a machine-implemented method, for acquiring measurement data from a non-destructive measurement instrument, without requiring a wired or wireless network connection to the measurement instrument.

FIG. 3 illustrates generally a technique, corresponding to a user workflow, for acquiring measurement data from a non-destructive measurement instrument, without requiring a wired or wireless network connection to the measurement instrument.

FIG. 4A shows an illustrative example of a measurement instrument (e.g., a digital thickness gauge), from which a measurement value can be extracted according to the present subject matter.

FIG. 4B shows an illustrative example of a portion of an opposite side of a housing of the measurement instrument (e.g., a digital thickness gauge) of FIG. 4A, from which metadata can be captured, such as for traceability or for controlling a machine-implemented method for acquiring measurement data.

FIG. 5 illustrates a block diagram of an example comprising a machine 500 upon which any one or more of the techniques (e.g., methodologies) discussed herein may be performed.

### DETAILED DESCRIPTION

The present inventor has recognized among other things that various mechanical measurement instruments, such as non-destructive measurement instruments, provide a digital display for readout of measurement results and other information by a user. Many such devices were designed without any wired or wireless networking capability, or when present, such networking capabilities are not always available or operable in the field. Accordingly, for devices with no wireless or wired networking capability, such as legacy devices, or for devices where network connectivity is not available, measurements are generally acquired manually, and results are handwritten or manually entered into an electronic form. Such hand entry is inefficient and error prone. The present subject matter can be used to automate data entry through the use of an analysis of bitmap images acquired using a digital image sensor, such as using a smart device.

As an illustration, an application on a smart device such as a smart phone or tablet can be used to acquire a video stream. The video stream can include a view focused on a display of a measurement instrument, such as a digital thickness gauge or other non-destructive measurement instrument, to extract measurements or other information, such as contextual information (e.g., make, model, or serial number of a non-destructive measurement instrument). Generally, a video stream comprises a series of respective bitmap images. The techniques described herein can be applied to one or more such bitmap images either acquired individually or included as a portion of a video stream (e.g., as frames showing a field of view of interest extracted from a video stream). An acquired measurement value extracted from a bitmap image can be used to either populate a measurement value or related metadata into a data field in an application, or to otherwise acquire and store such data without requiring a wired or wireless communication link with the measurement instrument. Similarly, other measurement information such as a bitmap image of a display (e.g., showing an A-scan or eddy current plane) could be similarly captured, and could be converted to numerical data values such as time-series or X-Y (cartesian) coordinate data.

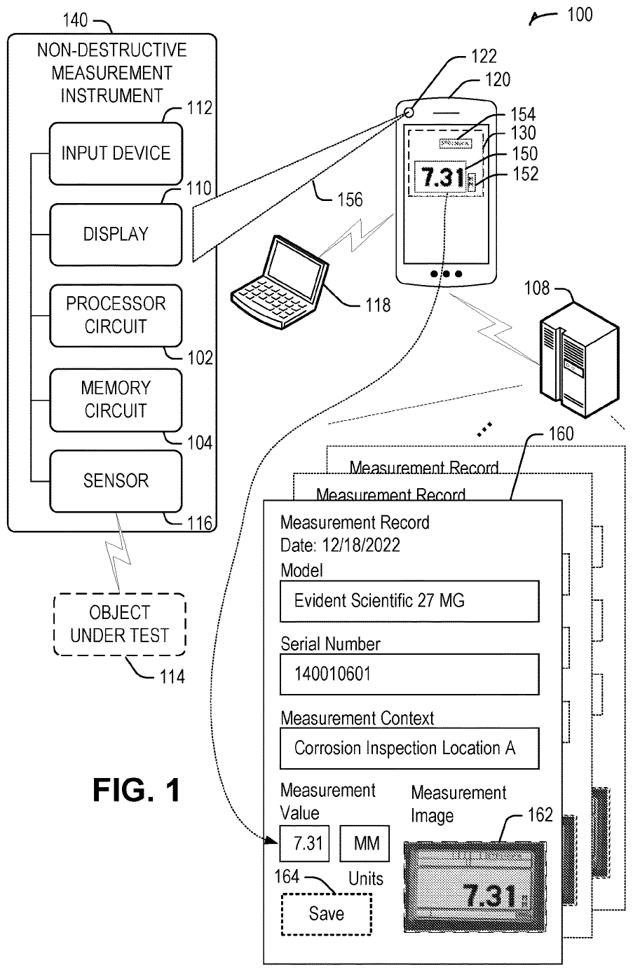

FIG. 1 illustrates generally an example comprising a system 100 that can be used to perform a machine-implemented method for acquiring measurement data from a non-destructive measurement instrument 140, without requiring a wired or wireless network connection to the non-destructive measurement instrument 140. Generally, the non-destructive measurement instrument 140 is a hand-held or portable assembly, such as can include a digital gauge (e.g., a thickness gauge such as an ultrasonic thickness measurement (UMT) unit) or another instrument. The non-destructive measurement instrument 140 can include a sensor 116 such as a transducer for transmitting or receiving energy used for performing measurements to evaluate a characteristic of an object under test 114. The sensor 116 can include one or more sensing modalities, such as comprising an optical, magnetic, or acoustic transducer, as illustrative examples. The non-destructive measurement instrument 140 can include a processor circuit 102, such as coupled to a memory circuit 104 comprising firmware or other operating instructions that when executed by the processor circuit 102, cause the non-destructive measurement instrument 140 to present a measurement or other information on a display 110 (e.g., a liquid crystal display, a light-emitting diode display, or other reflective or emissive display that is human-readable). The non-destructive measurement instrument 140 can include an input device 112 such as a keypad, touchscreen, soft-keys, or the like.

As mentioned above, in one approach, a user (e.g., an operator of the non-destructive measurement instrument 140) may use a smart device 120 such as a mobile device or tablet, a laptop computer 118, or even a paper form, to manually record measurement results according to specified test protocol. The test protocol may be established according to a published standard or regulatory requirement and may be performed upon initial fabrication or on a recurring basis for ongoing surveillance, as illustrative examples. For example, an application can guide the operator and prompt the operator to enter measurement results in response to prompts provided on the smart device 120 or the laptop computer 118 (e.g., in a measurement record 160 form with an input 164 to save the entered data). Resulting data can be captured in electronic form, such as corresponding to measurement records 160 established and stored on the smart device 120, the laptop computer 118, or a remote facility such as a cloud facility 108 (e.g., network-based resources providing one or more of processor circuit facilities or data storage facilities) communicatively coupled with the smart device 120 or the laptop computer 118.

According to the present subject matter, the non-destructive measurement instrument 140 need not have any wired or wireless networking capability. A user can place an acquisition device such as the smart device 120 such that the display 110 is within a field of view 156 of an image sensor 122 (e.g., a digital camera) included as a portion of the smart device 120. In this manner, a bitmap image 130 (or multiple such images, such as comprising a video stream) can be acquired. As discussed further below, data can be extracted from the bitmap image 130, such as using approaches such as image segmentation and optical character recognition. Contextual data, such as a metadata comprising a make, model, firmware version, serial number, or other identifying information can be used to determine candidate data to extract from the bitmap image 130. For example, the bitmap image 130 can be segmented to identify a measurement value 150, a unit of measure 152, and a presence or absence of one or more indicia such as an annunciator 154. An extracted measurement value 150 can be entered in a corresponding measurement record 160, such as with manual or automatic entry of other contextual information (e.g., metadata), such as time/date of measurement, location, or measurement instrument data (e.g., model, serial number, calibration date, firmware revision, or the like). Other traceability information such as a representation 162 of the actual captured bitmap image can be stored in or associated with a corresponding measurement record 160. In this manner, entry of measurement results acquired using the non-destructive measurement instrument 140 can be automated, avoid hand entry and enhancing traceability, for example.

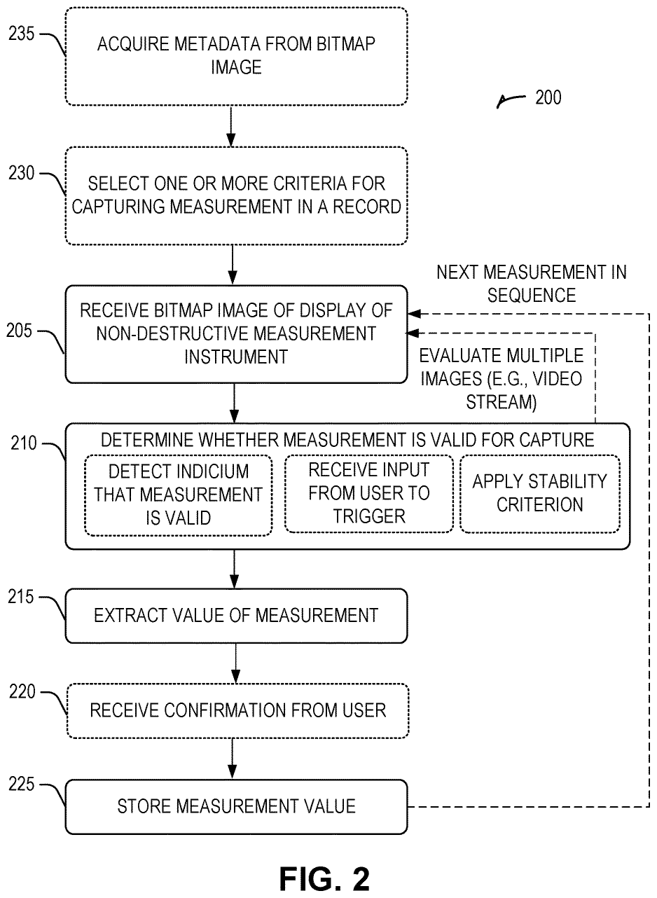

FIG. 2 illustrates generally a technique, such as a machine-implemented method 200, for acquiring measurement data from a non-destructive measurement instrument, without requiring a wired or wireless network connection to the measurement instrument. In the machine-implemented method 200, at 205, a bitmap image of a display of a non-destructive measurement instrument can be received. For example, as discussed below, such a bitmap can be captured from a video stream acquired using a smart device. Boundaries of the display can be identified based on user input or automatically, such as using image segmentation, edge detection, or another approach (e.g., cropping an image based on a contrast gradient defining an edge of the display region). At 210, a determination can be made whether a measurement is valid for capture. Such a determination can include receiving a selection from a user (such as pressing a touchscreen display on a smart device to trigger image capture or pressing a physical button on the smart device), or detecting that the display contains indicium having a state indicative that the measurement is valid (such as a “freeze,” “hold,” or “stable” indicium, a lamp being lit or extinguished to indicate measurement stability, or a symbol being shown or hidden to indicate stability). The determination at 210 can include applying another criterion, such as a stability criterion. For example, a series of extracted measurement values can be determined, and the stability criterion can be to evaluate how much the measurement values vary from each other. When such evaluation indicates that the measurement values do not vary from each by more than a specified margin over a specified duration (such as a user-specified duration, or as indicated by other user input, or based on a pre-established duration), a measurement can be deemed valid (e.g., stable) for capture. As shown in FIG. 2, optionally, receiving bitmap images can occur serially, such as corresponding to a video stream, and determination of measurement validity at 210 can be performed on an ongoing basis on successive images until a validity criterion is met, or a respective bitmap image can be frame-grabbed from a video stream. The approach described in this document does not require use of a video stream, and data extraction can be performed on as few as a single static image acquired in response to user input or automatically.

At 215, a measurement value can be extracted. For example, a user input could identify a region of an image to use for extraction of measurement values, or regions containing such values could be identified and such values can be extracted automatically. Extraction of a measurement value can include use of a segmentation technique and associated optical character recognition to identify regions of a received bitmap image that are likely to contain text information. Such regions can be defined by a schema selected at 230 (e.g., establishing one or more criteria for capturing measurements, such as identifying regions of the display of the non-destructive measurement instrument that contain information such as measurement data, measurement units, status indicators, etc.). Identification of a schema can be based on metadata acquired from a bitmap image at 235, such as discussed elsewhere herein.

In an example, the smart device can instantiate a machine learning model such as a trained neural network or other model that has been trained to identify display information from a corresponding non-destructive measurement instrument. Such a model can perform object detection (e.g., labeling) to locate relevant display elements like measurement values, units, and mode indicators. The model can then extract associated text and symbols output the measurement details in plain text. In an example, a user input can be received to identify a region of an image to use for extraction of measurement values. Depending on the model used, in an example, no prior knowledge of the display configuration or arrangement is required in order to extract measurement values at 215.

Optionally, at 220, a user input can be received confirming that an extracted measurement is suitable for logging, and at 225, the measurement value can be stored, such as automatically populating a field in a data logging application or otherwise being stored in a measurement record. Such storage can include saving the values in a defined data structure such as associated with a data acquisition application or record, or making the extracted data available to be “pasted” into a record from a clipboard or scratchpad in the memory of a smart device. As shown in FIG. 2, if multiple measurements are to be performed (such as according to a specified non-destructive test protocol), the machine-implemented method 200 can include cycling to the next field in an application form and acquiring another measurement in the test protocol sequence, using a process similar to the prior measurement. In this manner, acquiring multiple measurements and logging of the associated measurement values can be automated and streamlined, reducing error and enhancing traceability. In another example, the measurement value is amongst a series of values, such as representing time-series data or an X-Y representation, such as corresponding to an acoustic A-scan acquisition, or an eddy current plane, respectively, as illustrative examples.

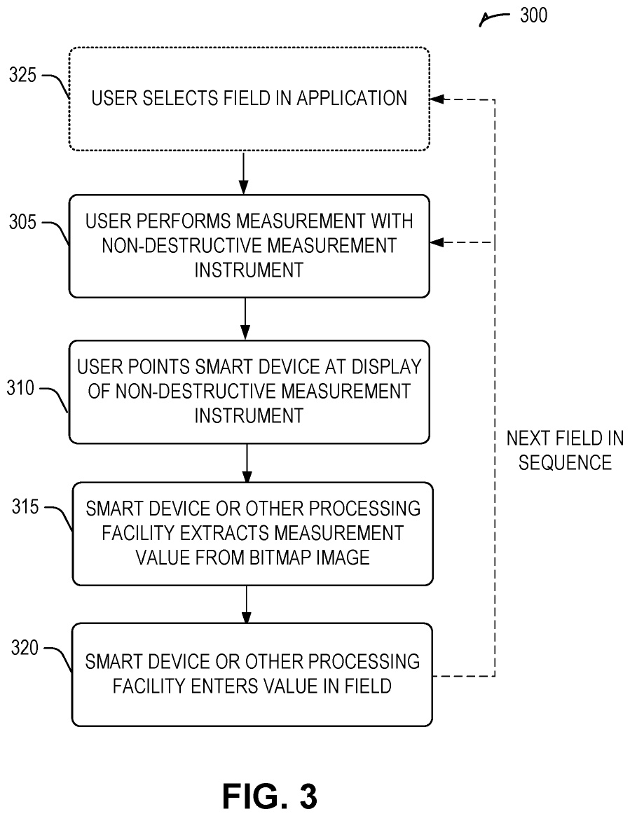

FIG. 3 illustrates generally a technique, corresponding to a user workflow 300, for acquiring measurement data from a non-destructive measurement instrument, without requiring a wired or wireless network connection to the measurement instrument. FIG. 3 can represent an illustrative example of a use case, such as can include or use portions of the system 100 shown in FIG. 1 and the method 200 of FIG. 2. For example, at 305, a user can perform a measurement. For example, the user can place the measurement device (e.g., thickness gauge) on the object under test to obtain a measurement in a manner similar for manual data entry. For example, the user can trigger acquisition of a measurement or inspect the display of the non-destructive measurement instrument to determine that an appropriate measurement value is displayed, such as “holding” or “freezing” the displayed value. At 310, the user can point a digital camera of a smart device at the display of the non-destructive measurement instrument. At 315, the smart device (or other processing facility) can analyze one or more bitmap images acquired using the smart device to extract a measurement value from a bitmap image, such as identifying an extracting text from a cropped image representing the display of the non-destructive measurement instrument.

At 320, the smart device or other processing facility can enter the value in an appropriate record for storage. For example, at 325, the user can launch an application on the smart device and select a field (or confirm that an appropriate field for measurement entry is active). At 320, the smart device or other processing facility can enter the value in the selected field (such as after receiving a user input indicating that the measurement is acceptability or generating a corresponding query to a user requesting approval of the extracted measurement value). As shown in the measurement record 160 of FIG. 1, other data can also be populated automatically, such as metadata or units of measurement. As shown in FIG. 3, various operations can be repeated for multiple measurements, such as to populate a sequence of fields according to an inspection protocol. In another example, if a sequence of measurement values are obtained, other data extraction modes can be used, such as determining a minimum measurement value and a maximum measurement value from a sequence of extracted measurement values, and logging such extrema in a respective fields.

The use case of FIG. 3 does not require that all operations are performed in response to user input (or even that any user input is required), or that a certain sequence must be followed. For example, a smart device or other assembly having a digital image sensor can be oriented to capture an image of a display of the non-destructive measurement instrument, such as before performing a measurement at 305. For example, if a user literally has their hands full and is unable to manipulate a smart device, the smart device could be set up ahead of time to capture a video stream, or another image capture device can be used. The user can then perform a measurement without having to separately manipulate the smart device. In another example, the user can orient a smart device or another image capture device to acquire an image of a display of a non-destructive measurement instrument, where the non-destructive measurement instrument is being automatically or remotely controlled or manipulated by a motion control or robotic system (e.g., where the user is not literally performing the measurement by hand manipulation of the measurement instrument).

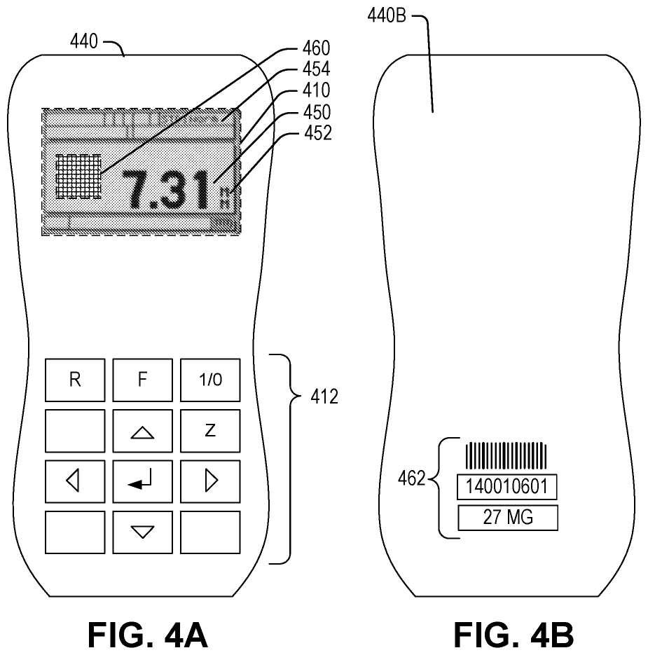

As discussed above, the techniques described in this document are generally applicable to automatically extracting and logging measurement values through imaging of a display of a non-destructive measurement instrument. One class of instruments are digital thickness gauges. Such gauges frequently lack any sort of wired or wireless networking capability, and data obtained from such gauges is recorded manually. FIG. 4A shows an illustrative example of a measurement instrument 440 (e.g., a digital thickness gauge), from which a measurement value can be extracted according to the present subject matter. In FIG. 4A, the measurement instrument 440 can include a user input 412, such as a keypad to receive various inputs (e.g., “R” for reset, “F” for freeze display, “1/0” to cycle power, and soft direction keys and an enter key to move a cursor on a display 410 or select options.

The display 410 can include a bit-field display or other display (e.g., having defined elements such segments of digits, text, or symbols). When measurement is performed, the display can show a measurement value 450 (“7.31 ” in this illustrative example), and units of measurement 452 (millimeters in this example). The display can include other information such as one or more annunciators (e.g., an indicium 454 as shown).

The display may also include a region 460 that be controlled by the measurement instrument 440 specifically to facilitate automated recognition and extraction of measurement values. For example, legacy devices can have an upgradeable firmware that can be updated specifically to provide indicia to indicate that a measurement is stable, valid, ready for capture, not ready for capture, or other information for automatic readback by a smart device using the camera of the smart device. For example, the display 410 can provide a time-varying digital representation of metadata to be read by the smart device or other processing facility, encoded in the region 460.

As discussed above, other information can be logged for traceability or quality review. For example, it may be desirable to capture a model and serial number of the measurement instrument (e.g., thickness gauge) or other traceability information such as firmware revision or calibration date. Such information can be manually entered or extracted automatically in a manner similar to extraction of measurement values from the display 410. For example, FIG. 4B shows an illustrative example of a portion of an opposite side of a housing 440B of the measurement instrument 440 (e.g., a digital thickness gauge) of FIG. 4A, from which metadata can be captured, such as for traceability or for controlling a machine-implemented method for acquiring measurement data. A data plate 462 (e.g., a label or other region on the measurement instrument 440) can include various information such as barcode corresponding to a serial number, the serial number in text form, a model number (“27 MG”), or other information. The machine-implemented method 200 shown herein can automatically enter specified information (in this example, Model 27 MG and Serial Number 140010601) extracted from a bitmap image into specified fields in a measurement record or use such information in selecting one or more criteria for capturing the measurement in a record, such as selecting a model to use for text extraction, or a schema defining regions of a display to be evaluated for measurement data extraction, as examples.

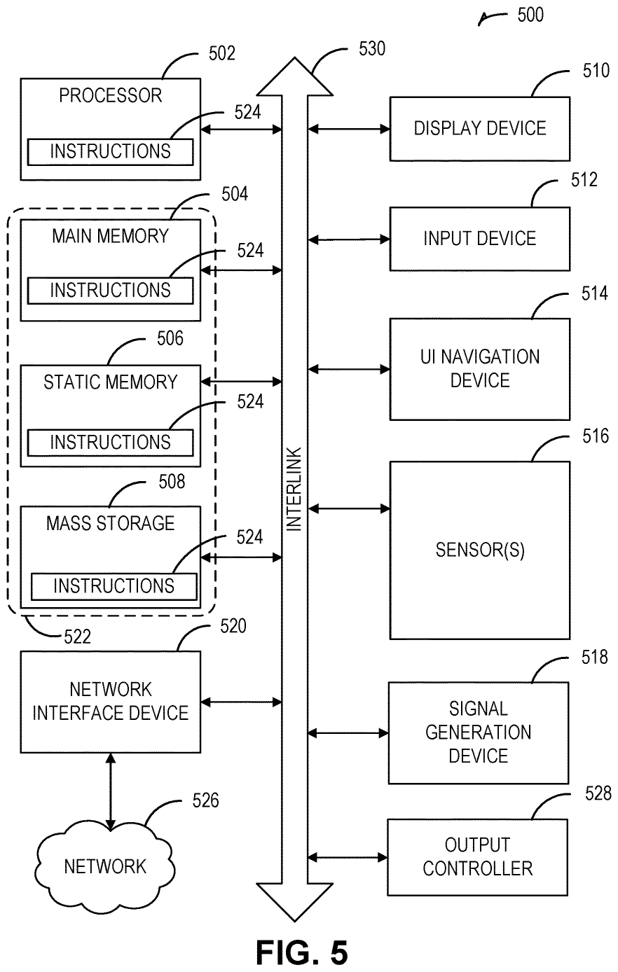

FIG. 5 illustrates a block diagram of an example comprising a machine 500 upon which any one or more of the techniques (e.g., methodologies) discussed herein may be performed. Generally, the machine 500 of FIG. 5 can be included as a portion of a smart device or another processing facility to implement a portion or an entirety of various machine-implemented methods described in this document. Processing of an acquired bitmap image to extract measurement data can be performed locally on a smart device, or remotely, or using a combination of local and remote processing facilities. For example, an image can be transmitted to a remote processing facility comprising a portion or entirety of machine 500 as shown in FIG. 5, and a resulting measurement value or measurement data that has been extracted can be transmitted back to the smart device for other use such as logging, recording, or display to a user.

Machine 500 (e.g., computer system) may include a hardware processor 502 (e.g., a central processing unit (CPU), a graphics processing unit (GPU), a hardware processor core, or any combination thereof), a main memory 504 and a static memory 506, connected via an interlink 530 (e.g., link or bus), as some or all of these components may constitute hardware for systems or related implementations discussed above.

Generally, the hardware processor 502 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory 504 include Random Access Memory (RAM), and semiconductor memory devices, which may include storage locations in semiconductors such as registers. Specific examples of static memory 506 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 500 may further include a display device 510, an input device 512 (e.g., a keyboard), and a user interface (UI) navigation device 514 (e.g., a mouse). In an example, the display device 510, input device 512, and UI navigation device 514 may be a touch-screen display. The machine 500 may include a mass storage device 508 (e.g., drive unit), a signal generation device 518 (e.g., a speaker), a network interface device 520, and one or more sensors 516, such as a global positioning system (GPS) sensor, compass, accelerometer, or some other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 508 may comprise a machine-readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the mass storage device 508 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 524.

An apparatus of the machine 500 includes one or more of a hardware processor 502 (e.g., a central processing unit (CPU), a graphics processing unit (GPU), a hardware processor core, or any combination thereof), a main memory 504 and a static memory 506, sensors 516, network interface device 520, antennas, a display device 510, an input device 512, a UI navigation device 514, a mass storage device 508, instructions 524, a signal generation device 518, or an output controller 528. The apparatus may be configured to perform one or more of the methods or operations disclosed herein.

The term “machine readable medium” includes, for example, any medium that is capable of storing, encoding, or carrying instructions for execution by the machine 500 and that cause the machine 500 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 524 may be transmitted or received, for example, over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 520 includes one or more physical jacks (e.g., Ethernet, coaxial, or other interconnection) or one or more antennas to access the communications network 526. In an example, the network interface device 520 includes one or more antennas to wirelessly communicate using at least one of single-input multiple-output (SIMO), multiple-input multiple-output (MIMO), or multiple-input single-output (MISO) techniques. In some examples, the network interface device 520 wirelessly communicates using Multiple User MIMO techniques. The term “transmission medium” shall be taken to include any intangible medium that is capable of storing, encoding or carrying instructions for execution by the machine 500, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A machine-implemented method for acquiring measurement data from a non-destructive measurement instrument, without requiring a wired or wireless network connection to the non-destructive measurement instrument, the method comprising:
receiving a bitmap image of a display of the non-destructive measurement instrument using an image sensor;
determining whether the bitmap image of the display contains a measurement that is valid for capture; and
in response, if the determination indicates the measurement is valid for capture, capturing the measurement in a record by extracting a value of the measurement from the bitmap image and storing the value.

2. The machine-implemented method of claim 1, wherein the bitmap image is amongst bitmap images comprising a video stream.

3. The machine-implemented method of claim 2, wherein determining whether the bitmap image of the display contains a valid measurement for capture comprises receiving a selection from a user, triggering capture of the measurement in the record.

4. The machine-implemented method of claim 2, wherein determining whether the bitmap image of the display contains a valid measurement for capture comprises automatically evaluating a stability criterion.

5. The machine-implemented method of claim 4, wherein the stability criterion comprises extracting a series of measurement values from respective bitmap images comprising the video stream, and triggering capture of the measurement in the record when the series of values indicate that the measurement has stabilized.

6. The machine-implemented method of claim 5, wherein the stability criterion comprises determining a series of extracted measurement values do not vary from each by more than a specified margin over a specified duration.

7. The machine-implemented method of claim 1, wherein determining whether the bitmap image of the display contains a valid measurement for capture comprises determining a state of an indicium on the display other than a measurement value.

8. The machine-implemented method of claim 7, wherein the indicium comprises determining a state of an annunciator, a symbol, or a lamp associated with the display.

9. The machine-implemented method of claim 1, wherein determining whether the bitmap image of the display contains a valid measurement for capture includes receiving from the display an indicium other than a measurement value indicative that the display is showing a stable measurement.

10. The machine-implemented method of claim 1, comprising acquiring metadata from a bitmap image of at least a portion of the non-destructive measurement instrument.

11. The machine-implemented method of claim 10, wherein the metadata comprises at least one of an instrument model, an instrument serial number, or an identifier of a structure under test being inspected using the non-destructive measurement instrument.

12. The machine-implemented method of claim 10, wherein the bitmap image of at least a portion of the non-destructive measurement instrument is used to select one or more criteria for capturing the measurement in a record.

13. The machine-implemented method of claim 1, wherein capturing the measurement in a record by extracting a value of the measurement from the bitmap image and storing the value comprises storing both the value and at least a portion of the bitmap image from which the value was extracted.

14. The machine-implemented method of claim 1, wherein the record corresponds to an electronic form or application where measurement data is otherwise manually entered by a user.

15. A system comprising:
at least one processor circuit and data storage facility; and
a non-destructive measurement instrument comprising a display;
wherein the at least one processor circuit and data storage facility is configured to perform a machine-implemented method, comprising:
receiving a bitmap image of a display of the non-destructive measurement instrument using an image sensor;
determining whether the bitmap image of the display contains a measurement that is valid for capture; and
in response, if the determination indicates the measurement is valid for capture, capturing the measurement in a record by extracting a value of the measurement from the bitmap image and storing the value.

16. The system of claim 15, wherein the at least one processor circuit and data storage facility is included as a portion of a smart device comprising one of a mobile device, a tablet device, a laptop device, or a wearable device.

17. The system of claim 15, wherein the at least one processor circuit and data storage facility is communicatively coupled to another device comprising an image sensor.

18. The system of claim 17, wherein the device comprising the image sensor comprises a smart device; and
wherein the at least one processor circuit and the data storage facility comprise network-based resources in communication with the smart device.

19. The system of claim 15, wherein the non-destructive measurement instrument comprises a digital thickness gauge.

20. A system for acquiring measurement data from a non-destructive measurement instrument, without requiring a wired or wireless network connection to the non-destructive measurement instrument, the system comprising:
a means for receiving a bitmap image of a display of the non-destructive measurement instrument using an image sensor;
a means for determining whether the bitmap image of the display contains a measurement that is valid for capture; and
a means for capturing the measurement in a record by extracting a value of the measurement from the bitmap image and storing the value, in response to an indication that the measurement is valid for capture.
